(19) United States
(12) Patent Application Publication
(10) Pub. No.: US 2014/0125033 A1
(43) Pub. Date: May 8, 2014

(54) WRAPPED STEERER TUBE SUITABLE FOR A BICYCLE

(71) Applicants: Philip Gordon White, Toronto, CA (US); Ted Peter Orfanogiannis, Mississauga (CA)

(72) Inventors: Philip Gordon White, Toronto, CA (US); Ted Peter Orfanogiannis, Mississauga (CA)

(21) Appl. No.: 13/667,417

(22) Filed: Nov. 2, 2012

(51) Int. Cl. B62K 19/32; B62K 19/06

(52) U.S. Cl. CPC B62K 19/32; B62K 19/06
USPC 280/279

(57) ABSTRACT

A steerer tube suitable for a bicycle fork assembly. The steerer tube comprises an inner tube formed of a metal, an outer layer, the outer layer being wrapped around a section of the metal inner tube; and the outer layer being formed of a material, wherein the material is lighter than the metal for the inner tube.

### FIELD OF THE INVENTION

The present invention relates to bicycles, and more particularly to a steerer tube configuration suitable for a bicycle and comprising a core formed of a metallic material and outer layer comprising a composite material.

### BACKGROUND OF THE INVENTION

On a bicycle, the steerer tube couples the fork to the handle bar stem. Steerer tubes were typically constructed of metal. While a metal construction is strong and resilient, metal, particularly, steel also tends to be heavy. As the sport of bicycle racing has developed, more and more emphasis is being placed on the utilization of new or lightweight materials to produce lighter components. Lighter components translate into a lighter bicycle, which, in turn, means less riding effort from the rider to propel the bicycle.

For instance in the art, the original steerer tubes made of steel were replaced by an aluminum construction. More recently, steerer tubes are being constructed of various fiber based materials, or combinations of fibers, i.e. composites, such as glass, Kevlar and carbon in a polymer or other matrix. The resulting steerer tubes are considerably lighter than the previous metal construction tubes.

It has, however, been found that while the fiber composite tubes are considerably lighter than the metal steerer tubes, the composite tubes are not as strong, rigid and/or wear resistant as the metal tubes. It has also been found that surface damage to a fiber composite steerer tube can result into failure or breakage of the tube. It will be appreciated that these characteristics can directly affect the performance, reliability and operating life of the fiber composite steerer tubes.

Accordingly, there remains a need for improvements in the art.

### BRIEF SUMMARY OF INVENTION

The present invention is directed to embodiments of a steerer tube suitable for a bicycle or other similar wheeled or steerable vehicle. According to an embodiment, the steerer tube comprises a two-part configuration or construction, and includes an inner member or core formed of a metallic type material and an outer member or component comprising a sleeve or wrap comprising a composite material.

According to one embodiment, the present invention comprises a steerer tube suitable for a bicycle, the steerer tube comprises: an inner tube formed of a metal; an outer layer, the outer layer being wrapped around a section of the metal inner tube; and the outer layer being formed of a material being lighter than the metal for the inner tube.

According to another embodiment, the present invention comprises a fork assembly suitable for a bicycle, the fork assembly comprises: a fork crown; a first fork affixed to the fork crown; a second fork affixed to the fork crown in a spaced relationship to the first fork; the first and the second forks being configured to receive a wheel; a steerer tube affixed to the fork crown, the steerer tube comprising an inner tube formed of a metal; an outer layer, the outer layer being wrapped around a section of the metal inner tube; and the outer layer being formed of a material, wherein the material is lighter than the metal for the inner tube.

Other aspects and features of the present invention will become apparent to those ordinarily skilled in the art upon review of the following exemplary embodiments of the invention in conjunction with the accompanying figures.

### BRIEF DESCRIPTION OF THE DRAWINGS

Reference is next made to the accompanying drawings, which show by way of example, one or more embodiments according to the present invention, and in which,

FIG. 1 shows a bicycle with a typical racing geometry and comprising a fork assembly configured with a steerer tube according to an embodiment of the present invention;

FIG. 2 shows a partial view of a fork assembly with a steerer tube according an embodiment of the present invention and configured to couple a handle bar stem;

FIG. 3 is a cross-sectional view of the steerer tube of FIG. 2 taken through line A-A; and

FIG. 4 is a cross-sectional view of a steerer tube according to another embodiment of the present invention.

Like reference numerals in the drawings indicate like elements or components.

### DETAILED DESCRIPTION OF THE EMBODIMENTS

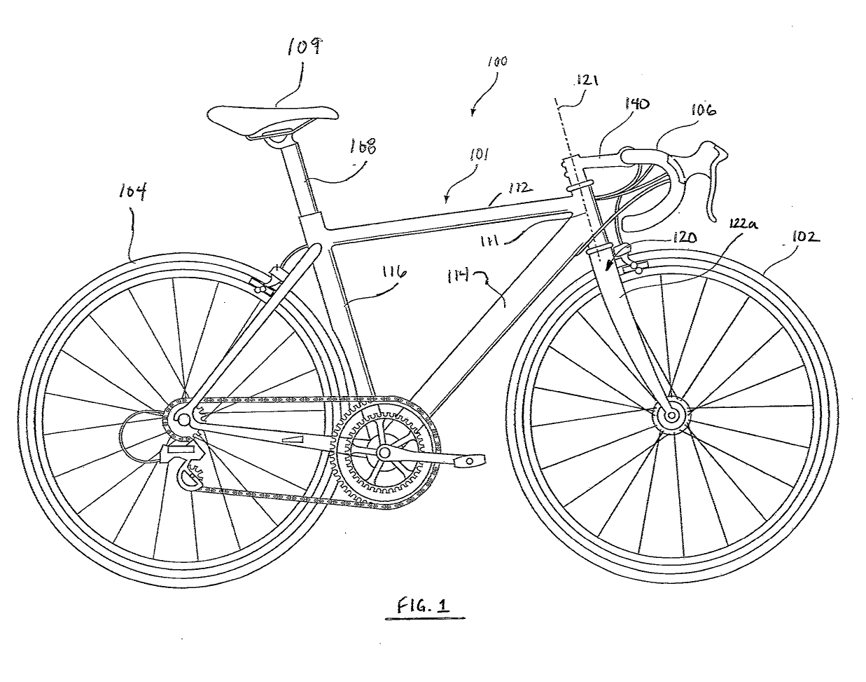

Reference is first made to FIG. 1 which shows a bicycle indicated generally by reference 100 and configured with a wrapped steered tube according to an embodiment of the present invention. As shown, the bicycle 100 comprises a frame 101, a front wheel 102, a rear wheel 104, handlebars 106 and a seat 108. The frame 101 comprises a head tube 111, a top tube 112, a down tube 114 and a seat tube 116, connected using known techniques to form a frame geometry, for example, a racing bicycle geometry, as will be within the understanding of one skilled in the art.

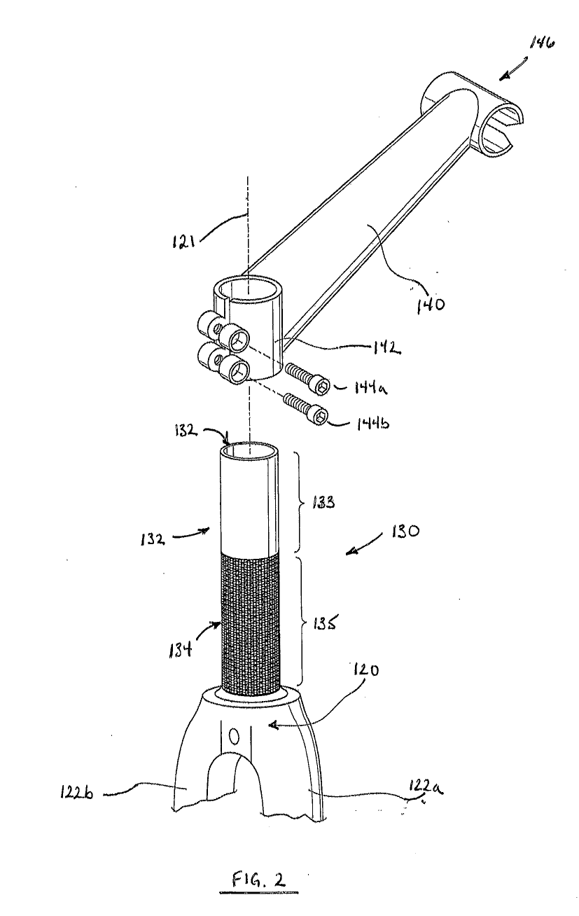

As also shown in FIG. 1, the seat tube 116 holds or houses a seat tube 108. A seat 109 is mounted to upper end of the seat tube 108 and height positioned for the rider. At the front end of the frame 101, a fork assembly 120 is rotatably coupled or mounted to the head tube 111 in known manner. The fork assembly 120 comprises a first (e.g. right) fork arm 122a and a second (e.g. left) fork arm 122b (FIG. 2). The fork arms 122 are coupled to the front wheel 102 in known manner.

As shown in FIG. 2, the fork assembly 120 comprises a steerer tube indicated generally by reference 130. The steerer tube 130 is configured to fit through the head tube 111 (FIG. 1) and is connected to a handle bar stem 140, which is configured, for example, with a clamp or collar 142 and bolt configuration 144a, 144b as depicted in FIG. 2. The handle bar stem 140 is configured, in known manner, at the other end 146 to mount or connect a pair of handlebars indicated generally by reference 106 (FIG. 1).

Referring still to FIG. 2, the steerer tube 130 according to an embodiment of the present invention comprises a two component or composite configuration. As shown, the steerer tube 130 comprises a tubular section or tube indicated generally by reference 132 and an outer layer or sleeve indicated generally by reference 134. As depicted, the steerer tube 130 comprises an upper end portion or section 133 and a lower end portion or section 135.

According to an embodiment, the tubular section 132 comprises a tube made or formed from a metal, for example, steel, titanium, aluminum, or other suitable metallic material. The tubular section 130 is joined or otherwise affixed to the fork assembly 120 using known fabrication techniques. The outer layer 134 comprises a composite material that is formed, applied or attached to the lower section 135 of the steerer tube 130, for example, as described in more detail below. The outer layer 134 (and the lower section 135) fit inside the head tube 111. The upper section 133 of the steerer tube 130 extends (at least partially) through the head tube 111 and is connected or joined to the handle bar stem 140 by the clamp collar 142.

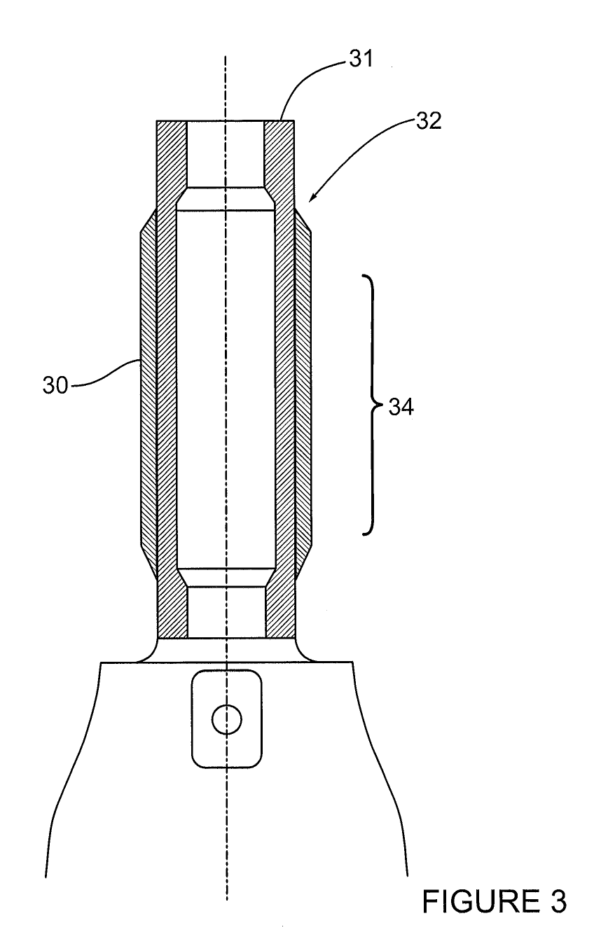

Reference is next made to FIG. 3, which shows a steerer tube 230 according to an embodiment of the present invention. As shown, the steerer tube 230 is connected or affixed to the fork assembly 120, and comprises a tubular section indicated by reference 232 and an outer layer indicated generally by reference 234. The steerer tube 230 also comprises an upper section 233 and a lower section 235. According to one aspect, the tubular section 232 comprises a metal tube, and the outer layer 234 comprises fiber composite material that is wrapped or applied to the lower section 235 of the steerer tube 230. The fiber composite material for the outer layer 234 is wrapped or applied to form a generally cylindrical outside surface and is disposed generally in line with longitudinal axis 121. According to an exemplary implementation, the outer layer 234 is formed of glass, Kevlar, carbon, metallic strands, or other suitable material, or any suitable combination thereof. According to an embodiment, the fibers are placed or configured in one or more different orientations with respect to the longitudinal axis 121 of the steerer tube 230. According to one embodiment, the fibers forming the outer layer 234 can be configured to be longitudinally oriented, circumferentially oriented and/or helically oriented about the steerer tube 230.

It will be appreciated that placing or configuring the fibers in different orientations can serve to further exploit the physical properties of the composite material. In general, composite fibers are orthotropic, i.e. the strength of the material depends on the direction of an applied force or load. Accordingly, by placing the composite fibers in the outer layer 234 in different directions or orientations (and different relative quantities) different types of strength or bending properties can be achieved for the outer layer 234 and the steerer tube 230.

According to one embodiment, the outer layer 234 is formed with the fibers for the composite material substantially aligned with the longitudinal axis 121. This configuration increases the bending strength of the steerer tube 230.

According to another embodiment, the outer layer 234 is formed with the fibers for the composite material substantially perpendicular or normal to the longitudinal axis 121. This configuration increases the hoop strength of the steerer tube 230.

According to another embodiment, the outer layer 234 is formed with the fibers for the composite material in substantially helical or helix arrangement (i.e. at orientation in the range of 45 to 50 degrees) to the longitudinal axis 121. This configuration increases the torsional or twisting strength of the steerer tube 230.

Accordingly, the directions of the fibers and relative quantity of fibers in each direction are adjusted depending on the strength requirements for the tube. For example, if a given steerer tube is desired to have increased hoop strength, additional fibers may be placed circumferentially around the tube normal to the longitudinal axis.

According to another aspect, the wall thickness of the inner metallic tube 232 is reduced or contoured in the lower section 235 of the steerer tube 230 in order to achieve a weight reduction. The outer wrap 234 functions, in turn, to provide additional strength to the steerer tube 230 without sacrificing the weight reduction resulting from the thinner section in the metallic tube 232. As described above, the fibers can be oriented to achieve a variety of strength and/or bending characteristics for the steerer tube 230. The weight of the inner metallic tube 232 may also be reduced by drilling holes or having perforations in the wall of the inner metallic tube 232.

According to another embodiment, the outer layer 234 can be formed as a separate component comprising a tube or sleeve with an inner diameter that closely fits the outside diameter of the inner metallic tube 232. The outer layer 234 is slid over the inner metallic tube 232 and joined or fixed into position using an adhesive or other suitable fastening technique. It will be appreciated that according to one aspect this method of construction can provide the arrangement of an internal metal tube bonded to an outer fiber composite layer, with the benefits of an outer fiber composite layer and an internal metal tube.

According to another embodiment, the outer layer 234 may be configured to span the lower section 235 and most or all of the upper section 233. Using such a configuration can allow further weight reduction in the inner metallic tube 232, for example, by reducing the wall thickness of the inner metallic tube 232, perforating the wall of the inner metallic tube 232, machining flutes into the wall of the inner metallic tube 232. The perforations can comprise holes, slots or the like. The flutes can be milled or otherwise machined into the outer wall and/or inner wall of the inner metallic tube 232.

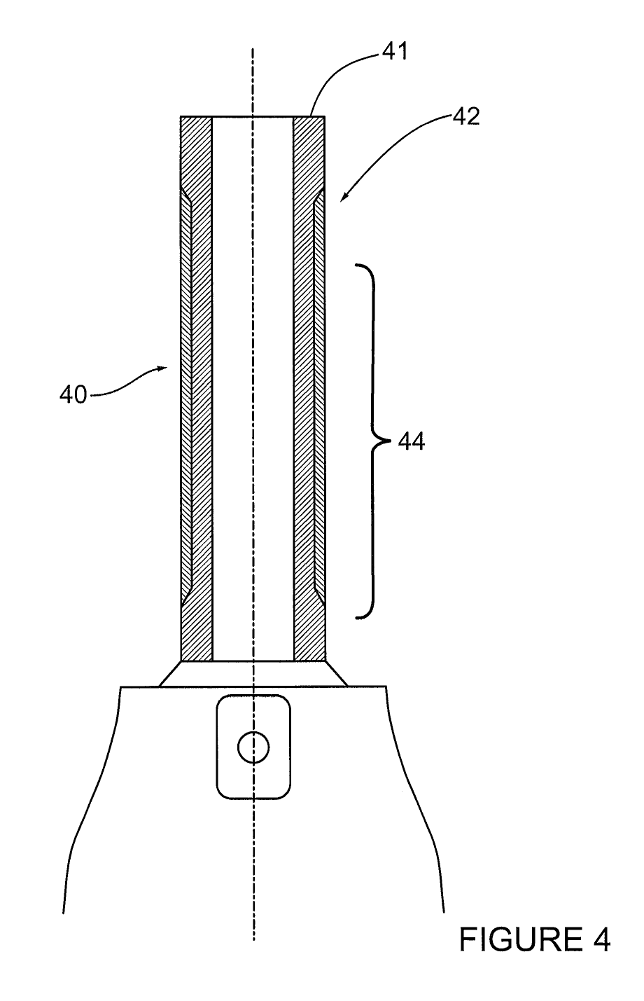

Reference is next made to FIG. 4, which shows a steerer tube according to another embodiment of the present invention and indicated generally by reference 330. The steerer tube 330 comprises a tubular section indicated by reference 332 and an outer layer indicated generally by reference 334. The steerer tube 330 also comprises an upper section 333 and a lower section 335. According to one aspect, the tubular section 332 comprises a metal tube, and the outer layer 234 comprises fiber composite material that is wrapped or applied to at least the lower section 335 of the steerer tube 330. According to this embodiment, the thickness of the outer wall of metallic tube 332 is reduced to form a collar-like configuration, and the outer layer wrap 334 is applied to the collar (i.e. reduced wall section of the inner metallic tube 332). As shown in FIG. 4, the outer layer wrap 334 is applied to achieve a constant outer diameter of the steerer tube 330, i.e. the fiber outer layer 334 increases the thickness over the length of the inner metallic tube steerer tube 332 where the wall thickness was reduced.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A steerer tube suitable for a bicycle fork assembly, the steerer tube comprises:
an inner tube formed of a metal;
an outer layer, said outer layer being wrapped around a section of said metal inner tube; and
said outer layer being formed of a material, wherein said material is lighter than the metal for the inner tube.

2. The steerer tube as claimed in claim 1, wherein said outer layer comprises a fiber composition formed in a solid matrix material.

3. The steerer tube as claimed in claim 2, wherein said fiber composition comprises a composition of one or more of glass fibers, carbon, Kevlar, metallic strands and other high strength fibers.

4. The steerer tube as claimed in claim 1, wherein said inner tube comprises a section with a thinner wall, and said outer layer being wrapped substantially around said thinner wall section.

5. The steerer tube as claimed in claim 1, wherein said inner tube comprises a plurality of perforations so as to reduce overall weight of said inner tube.

6. A fork assembly suitable for a bicycle, said fork assembly comprising:
a fork crown;
a first fork affixed to said fork crown;
a second fork affixed to said fork crown in a spaced relationship to said first fork;
said first and said second forks being configured to couple a wheel;
a steerer tube affixed to said fork crown, said steerer tube comprising
an inner tube formed of a metal;
an outer layer, said outer layer being wrapped around a section of said metal inner tube; and
said outer layer being formed of a material, wherein said material is lighter than the metal for the inner tube.

7. The fork assembly as claimed in claim 6, wherein said outer layer comprises a fiber composition formed in a solid matrix material.

8. The fork assembly as claimed in claim 7, wherein said fiber composition comprises a composition of one or more of glass fibers, carbon, Kevlar, metallic strands and other high strength fibers.

9. The fork assembly as claimed in claim 8, wherein some said fibers are configured in an orientation parallel to a longitudinal axis of said steerer tube.

10. The fork assembly as claimed in claim 8, wherein some said fibers are configured in an orientation perpendicular to a longitudinal axis of said steerer tube.

11. The fork assembly as claimed in claim 8, wherein some said fibers are configured in an angle less than approximately 50 degrees in relation to a longitudinal axis of said steerer tube.

12. The fork assembly as claimed in claim 6, wherein said inner tube comprises a plurality of perforations so as to reduce overall weight of said inner tube.

13. A bicycle comprising a fork assembly as claimed in claim 6.
